(19) United States
(12) Patent Application Publication
(10) Pub. No.: US 2022/0270360 A1
(43) Pub. Date: Aug. 25, 2022

(54) METHOD AND APPARATUS FOR AUTHENTICATION OF A THREE-DIMENSIONAL OBJECT

(71) Applicant: Technology Innovation Momentum Fund (Israel) Limited Partnership, Tel-Aviv (IL)

(72) Inventors: David MENDLOVIC, Tel-Aviv (IL); Raja GIRYES, Tel-Aviv (IL); Dana WEITZNER, Tel-Aviv (IL)

(73) Assignee: Technology Innovation Momentum Fund (Israel) Limited Partnership, Tel-Aviv (IL)

(21) Appl. No.: 17/636,904

(22) PCT Filed: Aug. 20, 2020
(86) PCT No.: PCT/IL2020/050917

§ 371 Date: Feb. 21, 2022

Related U.S. Application Data
(60) Provisional application No. 62/889,085, filed on Aug. 20, 2019.

(51) Int. Cl. G06V 10/82; G06V 10/147; G06V 10/50; G06T 7/50

(52) U.S. Cl. CPC G06V 10/82; G06V 10/147; G06V 10/507; G06T 7/50; G06V 2201/12

(57) ABSTRACT

A device for authentication of a three-dimensional object includes an imaging array having a sensor configured to generate first and second sparse views of a surface of the three-dimensional object that faces the imaging array, and a processing circuitry. The processing circuitry is configured to: interpolate the first and second sparse views to obtain first and second interpolated images; calculate a planar disparity function for a plurality of image pixels of one of the first or second interpolated images; generate a projected image by displacing the plurality of image pixels of one of the first or the second interpolated images using the planar disparity function; and compare the projected image with the other of the first or second interpolated images to determine conformance of the planar disparity function with the interpolated images of the surface of the object.

### RELATED APPLICATIONS

This application claims the benefit of U.S. Provisional Patent Application 62/889,085 filed Aug. 20, 2019, entitled “METHOD AND APPARATUS FOR AUTHENTICATION,” the contents of which are incorporated by reference as if fully set forth herein.

### BACKGROUND

The present invention relates to authentication in general, and in particular to a method and apparatus for authentication of a three-dimensional (3D) object, such as a face, and distinguishing of the 3D object from a two-dimensional (2D) spoof of the same object.

Automatic biometric verification is a fast-growing authentication tool for everyday systems, such as admission control systems, smartphones, or the like. Biometric identification may include face identification, iris identification, voice recognition, fingerprint recognition, or other tools. Of particular interest are facial recognition systems or methods, which are rather easy and convenient to use. Facial recognition is a convenient tool since the face is always available and exposed, and does not require the user to remember a password, to attach a finger which can be bothering if the user's hands are busy, or create any other nuisance.

A major enabler for this technology is the advance in deep learning methods, which can provide accurate recognition using 2D color imaging. In particular, facial recognition is widely used thanks to advances in deep learning techniques and the abundant labeled facial images available online, which enable deep learning training of such systems. However, methods relying on these images may be vulnerable to spoofing, i.e., gaining access by displaying a 2D print of a face of a legitimate user. Although current 2D face recognition methods that use Red-Green-Blue (RGB) images are accurate, they are still vulnerable to spoofing, i.e., may approve the identity based on an image of a legitimate user being displayed. Thus, an intruder or a person who obtained a smartphone of another person may present a picture of a legitimate user, and get access to the location, the device, or the like, which is a serious loophole of such systems.

To ensure the authenticity of the user, some existing solutions add a depth sensor, based on technologies such as Time of Flight or Structured Light. The depth sensor adds robustness against spoofing. However, compared to the standard 2 dimensional setup, the addition of these technologies increases the cost of the authentication system. Therefore, it is of great interest, especially for low-cost devices, to have a system that is resilient to 2D spoofing but does not increase the solution price.

### SUMMARY

It is accordingly an object of the present disclosure to provide a device that may distinguish between a 3D object and a 2D image of the same object, to thereby identify spoofing and prevent identifying a face based on presenting a 2D image. It is also an object of the present disclosure to provide a system and method that is configured to authenticate a 3D object at low cost, enabling safe facial authentication for low-cost devices. It is also an object of the present disclosure to provide a low-cost device that can verify that an object that is authenticated as 3D is a particular face, e.g., verifying that two images are of the same person. Thus, given a device or a system with a stored image, it may be verified that a person trying to use the device is the same person whose image is stored. The device may thus provide for a robust facial verification system.

According to a first aspect, a device for authentication of a three-dimensional object is disclosed. The device includes an imaging array having a sensor configured to generate first and second sparse views of a surface of the three-dimensional object that faces the imaging array, and a processing circuitry. The processing circuitry is configured to: interpolate the first and second sparse views to obtain first and second interpolated images; calculate a planar disparity function for a plurality of image pixels of one of the first or second interpolated images; generate a projected image by displacing the plurality of image pixels of one of the first or the second interpolated images using the planar disparity function; and compare the projected image with the other of the first or second interpolated images to determine conformance of the planar disparity function with the interpolated images of the surface of the object. If the projected image is substantially identical to the other interpolated image, this indicates that the planar disparity function matches the imaged object, i.e., that the object is two-dimensional. If, on the other hand, there are deviations between the projected image and the other interpolated images, this indicates that the planar disparity function does not apply to images of the object, i.e., that the object is three-dimensional. The device thus provides a low-computation and low-cost solution for distinguishing between 2D and 3D objects.

In another implementation according to the first aspect, the processing circuitry is configured to determine that the surface is three-dimensional when a deviation of the projected image and the other interpolated image from the planar disparity function is above a predetermined threshold. Optionally, the processing circuitry is configured to calculate the deviation based on a calculation of an l1 loss between the projected image and the other interpolated image. Because a disparity map for a three-dimensional object is not planar, the three-dimensional object is expected to deviate from the planar disparity function. Advantageously, the processing circuitry may incorporate a tolerance for minor deviation from the planar disparity function for two-dimensional objects, and thus conclude that the object is three-dimensional only when the deviation is above the predetermined threshold. For example, the tolerance may be used to exclude spoofing attempts based on showing of 2D images printed onto a surface with depth, e.g. a curved surface.

In another implementation according to the first aspect, the processing circuitry is configured to generate the projected image with between three and eight image pixels. Three image pixels, also described in this disclosure as “points,” are a minimum necessary for mapping a planar disparity function. The additional pixels may be measured to account for noise and ensure stability of the measurement. Advantageously, it is possible to determine whether the object is three-dimensional based on comparison of a small, finite number of image pixels, without requiring expensive and time-intensive computing of a comparison of the entire image.

In another implementation according to the first aspect, the processing circuitry is configured to compare the projected image with the other interpolated image on a pixel-by-pixel basis. Advantageously, it is thereby possible to further streamline the process of comparing the projected image with the other interpolated image. For example, the processing circuitry may be configured to check a conformance at a third pixel only if the first two checked pixels indicate that the object is two-dimensional.

In another implementation according to the first aspect, a memory is provided for storing images of surfaces of three-dimensional objects. The processing circuitry is configured to generate a depth map based on the first and second interpolated images. The processing circuitry is additionally configured to extract features from the first and second interpolated images and the depth map onto at least one network, and to compare the extracted features with features extracted from a corresponding image from a set of stored images, and to thereby determine whether the object is identical to an object imaged in the corresponding image.

Optionally, the at least one network comprises a multi-view convolutional neural network including a first convolutional neural network for processing features of the first interpolated image and generating a first feature vector, a second convolutional neural network for processing features of the second interpolated image and generating a second feature vector, a third convolutional neural network for processing features of the depth map and generating a third feature vector, and at least one combined convolutional neural network for combining the three feature vectors into a unified feature vector for comparison with a corresponding unified feature vector of the corresponding image. This network architecture may advantageously provide a computing environment suitable for performing a facial comparison using images obtained with a monochromatic sensor, without requiring a more robust computation based on RGB images.

Optionally, the stored images are images of faces. Advantageously, the device may thus include a threshold determination of whether an object is 2D or 3D, without requiring a significant amount of computing power, as well as a more robust mechanism for matching a face to a face in a database, once the identification of the object as 3D has been established.

According to a second implementation, a device for authentication of a three-dimensional object is disclosed. The device comprises: an image sensor comprising a plurality of sensor pixels configured to image a surface of the object facing the image sensor; a lens array comprising at least first and second apertures, at least one filter array configured to allow light received through the first aperture only to a set of first sensor pixels from the plurality of sensor pixels and light received through the second aperture only to a set of second sensor pixels from the plurality of sensor pixels. Processing circuitry is configured to generate a first sparse view of the object from light measurement of the set of first sensor pixels and a second sparse view from light measurement of the set of second sensor pixels. The processing circuitry is further configured to determine conformance of image pixels from the first and second sparse views with a planar disparity function calculated based on a baseline of the first and second apertures and a pixel focal length of the lens array. For example, the processing circuitry may generate interpolated views from the sparse views, calculate the planar disparity function at a plurality of image pixels, apply the planar disparity function at the image pixels of one of the interpolated views to generate a projected image, and compare the projected image with the other of the interpolated views to determine conformance of the planar disparity function with the different images. In such implementations, the disparity function is applied to images ultimately derived from the sparse views generated from the device. The device thus provides a low-computation and low-cost solution for distinguishing between 2D and 3D objects.

In another implementation according to the second aspect, the processing circuitry is further configured to determine the conformance of the image pixels from the first and second sparse views with the planar disparity function by interpolating the first and second sparse views to obtain first and second interpolated images; generating a projected image by displacing a plurality of image pixels of one of the first or the second interpolated images using the planar disparity function, and comparing the projected image with the other of the first or second interpolated images. Optionally, the processing circuitry is configured to determine that the surface is three-dimensional when a deviation of the projected image and the other interpolated image from the planar disparity function is above a predetermined threshold. If the projected image is substantially identical to the other interpolated image, this indicates that the planar disparity function matches the imaged object, i.e., that the object is two-dimensional. If, on the other hand, there are deviations between the projected image and the other interpolated images, this indicates that the planar disparity function does not apply to images of the object, i.e., that the object is three-dimensional.

In another implementation according to the second aspect, the at least one filter array comprises a coding mask comprising at least one blocked area configured to block light from reaching one or more of the plurality of the sensor pixels. Optionally, the at least one blocked area blocks light from reaching at least 25% and at most 75% of the plurality of sensor pixels. The blocked area may further optionally block light from reaching at least 40% and at most 60% of the plurality of sensor pixels. The coding mask may be designed and oriented in a manner that ensures sufficient differences between the first and the second sparse views.

In another implementation according to the second aspect, the at least one filter array comprises a filter associated with each aperture from the plurality of apertures. Each filter passes one or more wavelengths from a plurality of wavelengths, and no wavelengths passed by respective filters overlap. Each sensor pixel from the plurality of sensor pixels is adjacent to a pixel filter passing at least part of the wavelengths from the plurality of wavelengths. As a result, each sensor pixel measures light received through exactly one of the apertures. The wavelength-based filters may be, for example, in the visible range (e.g., RGB filters) or in the near-infrared range. Advantageously, the wavelength-based filters are readily available and easily implementable. In addition, the near-infrared range may be used to capture images in low-light situations, e.g. at night.

In another implementation according to the second aspect, the aperture structure comprises a first aperture and a second aperture. The at least one filter array comprises a first filter associated with the first aperture and a second filter associated with the second aperture. The first filter and the second filter are at a phase difference of 90°. Each sensor pixel from the plurality of sensor pixels is adjacent to a pixel filter having a phrase corresponding to a phase of the first filter or the second filter. As a result, each pixel measures light received through exactly one of the first aperture and the second aperture. The phase-based filters thus provide an easily implementable, low-cost solution for separating views received by different sensor pixels.

In another implementation according to the second aspect, the first aperture and the second aperture are arranged horizontally. In another implementation according to the second aspect, the first aperture and the second aperture are arranged vertically. In another implementation according to the second aspect, the plurality of apertures comprise at least two apertures arranged horizontally and at least two apertures arranged vertically. In such scenarios, it is possible to generate two sets of two sparse views, each displaced in a different direction, and to compare each of the two sets using the planar disparity function. Generating multiple sets of sparse views may increase an effective ability of the device to detect spoofing attempts by enabling two-dimensional comparison of sparse views.

According to a third aspect, a method for authentication of a three-dimensional object is disclosed. The method comprises: generating first and second sparse views of a surface of the three-dimensional object; interpolating the first and second sparse views of the object to obtain first and second interpolated images; generating a projected image by displacing a plurality of image pixels of one of the first or the second interpolated images using a planar disparity function; and comparing the projected image with the other of the first or second interpolated images to determine a conformance of the planar disparity function with the interpolated images of the object. If the projected image is substantially identical to the other interpolated image, this indicates that the planar disparity function matches the imaged object, i.e., that the object is two-dimensional. If, on the other hand, there are deviations between the projected image and the other interpolated images, this indicates that the planar disparity function does not apply to images of the object, i.e., that the object is three-dimensional. The device thus provides a low-computation and low-cost solution for distinguishing between 2D and 3D objects.

In another implementation according to the third aspect, the method further comprises determining that the surface is three-dimensional when a deviation of the projected image and the other interpolated image from the planar disparity function is above a predetermined threshold. Optionally, the method further comprises determining the deviation based on a calculation of an l1 loss between the projected image and the other interpolated image. Because a disparity map for a three-dimensional object is not planar, the three-dimensional object is expected to deviate from the planar disparity function. Advantageously, the method incorporates a tolerance for minor deviation from the planar disparity function for two-dimensional objects, and thus reaches a conclusion that the object is three-dimensional only when the deviation is above the predetermined threshold. For example, the tolerance may be used to exclude spoofing attempts based on showing of 2D images printed onto a surface with depth, e.g. a curved surface.

In another implementation according to the third aspect, the step of generating a projected image comprises generating the projected image with between three and eight image pixels. Three image pixels are a minimum necessary for mapping a planar disparity function. The additional pixels may be measured to account for noise and ensure stability of the measurement. Advantageously, it is possible to determine whether the object is three-dimensional based on comparison of a small, finite number of image pixels, without requiring expensive and time-intensive computing of a comparison of the entire image.

In another implementation according to the third aspect, the comparing step comprises comparing the projected image with the corresponding interpolated image on a pixel-by-pixel basis. Advantageously, it is thereby possible to further streamline the process of comparing the projected image with the other interpolated image. For example, the processing circuitry may be configured to check a conformance at a third pixel only if the first two checked pixels indicate that the object is two-dimensional.

In another implementation according to the third aspect, the method further comprises generating a depth map based on the first and second interpolated images, extracting features from the first and second interpolated images into at least one network, comparing the extracted features with features extracted from a corresponding image from a set of stored images, and thereby determining whether the object is identical to an object imaged in the corresponding image.

Optionally, the at least one network comprises a multi-view convolutional neural network, and the step of extracting features comprises processing features of the first interpolated image with a first convolutional neural network and generating a first feature vector, processing features of the second interpolated image with a second convolutional neural network and generating a second feature vector, processing features of the depth map with a third convolutional neural network and generating a third feature vector, and combining the three feature vectors into a unified feature vector with a combined convolutional neural network for comparison with a corresponding unified feature vector of the corresponding image. This network architecture may advantageously provide a computing environment and extracting method suitable for performing a facial comparison using images obtained with a monochromatic sensor, without requiring a more robust computation based on RGB images.

Optionally, the stored images are images of faces. Advantageously, the device may thus include a threshold determination of whether an object is 2D or 3D, without requiring a significant amount of computing power, as well as a more robust mechanism for matching a face to a face in a database, once the identification of the object as 3D has been established.

In another implementation according to the third aspect, the method further comprises training the at least one network with the set of stored images using a triplet loss technique. The training of the network is especially advantageous when the images are faces obtained with a monochromatic sensor, for which there are limited examples in existing image databases. The method may further comprise generating the images or views for the training process and then training the network on the basis of the generated images or views.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE OF THE SEVERAL VIEWS OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a schematic illustration of a vertical cut through of a device for authentication of a three-dimensional object having a coding mask, in accordance with some exemplary embodiments of the disclosed subject matter;

FIG. 1B is a schematic illustration of light from different apertures reaching different sensor pixels in the capture device of FIG. 1A, in accordance with some exemplary embodiments of the disclosed subject matter;

FIG. 1C is a schematic illustration of a vertical cut through of a device for authentication of a three-dimensional object having a polarization-based filter array, in accordance with some exemplary embodiments of the disclosed subject matter;

FIG. 1D is a schematic illustration of a vertical cut through of a device for authentication of a three-dimensional object having a wavelength-based filter array, in accordance with some exemplary embodiments of the disclosed subject matter;

FIG. 2 shows a coded image, a sparse view of the image and an interpolated image, in accordance with some exemplary embodiments of the disclosed subject matter;

FIG. 3 is a flowchart of a method for authentication of a three-dimensional object, in accordance with some exemplary embodiments of the disclosed subject matter;

FIG. 4 is a schematic illustration of an exemplary hardware and computing setting for authenticating a three-dimensional object, in accordance with some exemplary embodiments of the disclosed subject matter;

FIG. 5A depicts experimental results for training a neural network to distinguish between 2D and 3D images based on a synthetic face database, in accordance with some exemplary embodiments of the disclosed subject matter;

FIG. 5B depicts experimental results for training a neural network to distinguish between 2D and 3D images based on a real face database, in accordance with some exemplary embodiments of the disclosed subject matter;

FIG. 5C depicts ROC curves for the results of FIGS. 5A and 5B, in accordance with some exemplary embodiments of the disclosed subject matter; and

FIG. 6 is a block diagram of memory and processing unit for object verification and anti-spoofing, in accordance with some exemplary embodiments of the disclosed subject matter.

### DETAILED DESCRIPTION

The present invention relates to authentication in general, and in particular to a method and apparatus for authentication of a three-dimensional (3D) object, such as a face, and distinguishing of the 3D object from a two-dimensional (2D) spoof of the same object.

One problem addressed by the current disclosure relates to providing a device that may identify spoofing and thus prevent identifying a face based on presenting a 2D image.

Another problem addressed by the current disclosure relates to a system and method that provides for 3D sensing at low cost, enabling safe facial authentication for low cost devices.

Another problem addressed by the current disclosure relates to a low cost device that provides for automatic verification of a face, e.g. verifying that two images are of the same person. Thus, given a device or a system with a stored image, it may be verified that a person trying to use the device is the same person whose image is stored. Such solution, when combined with an anti-spoofing solution for initial exclusion of two-dimensional images prior to comparison of a person's face with a stored image of a face, may provide for a robust and efficient face verification system.

One technical solution disclosed in the present disclosure comprises the provisioning of an imaging device having a grayscale or monochromatic sensor and a binary coding mask, wherein the mask blocks some pixels of the camera sensor. An advantage of using a grayscale camera with a binary coding mask is that it makes the system inexpensive, without significantly reducing the achievable accuracy.

The device also comprises an aperture structure, which may be provided within the lens array. The aperture structure may comprise two or more apertures, wherein each aperture may be vertical, horizontal, mixed, or any combination thereof, and wherein the apertures may be arranged in any geometrical relationship. In some embodiments, there may be apertures that are aligned both horizontally and vertically. The coding mask and the aperture structure are inexpensive components, thus not adding significant cost to the imaging device.

Another technical solution comprises using the device comprising the aperture structure, the coding mask and the sensor for anti-spoofing. The light received through each aperture creates a different image on the grayscale sensor. Due to the blocked parts of the coding mask, some pixels of the sensor receive light through both apertures, other pixels receive light through a first aperture only, and yet others receive light through a second aperture only. Using images comprised of only the pixels that receive light from one aperture or the other but not both, and interpolating the rest of the pixels, the disparity between the two images may be computed in a small number of image pixels or points.

It will be appreciated by a person skilled in the art that planar objects, such as printed images, have planar disparity maps. Therefore, the planar disparity model, fitted to the measured disparity in at least three different points can be applied to a particular point in one image, and the result may be compared to the corresponding point in the other image. A high match, for example a difference being below a predetermined value for each point or for a combination, may indicate a 2D image, i.e. a spoofing attempt, while a low match may indicate a 3D surface of an object presented to the device.

Yet another technical solution comprises performing identity verification using the monochrome interpolated images and the disparity map, and comparing the interpolated images and disparity map against a pre-stored image. Due to the advances in deep learning, the resolution of the images may be sufficient for a trained engine to authenticate a user by the usage of monochrome images.

One technical effect of the disclosure is providing an inexpensive solution for adding components to a monochromatic capture device, such that the device can be used for user authentication.

Another technical effect of the disclosure is using a monochromatic capture device for face authentication which is also resilient to spoofing.

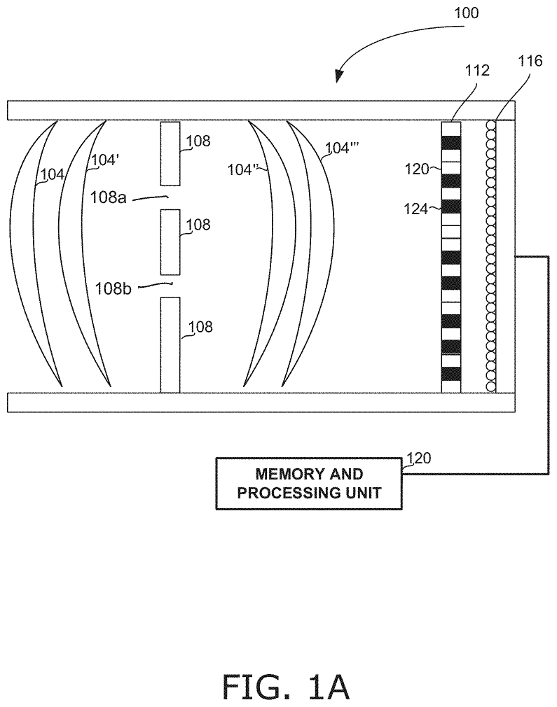

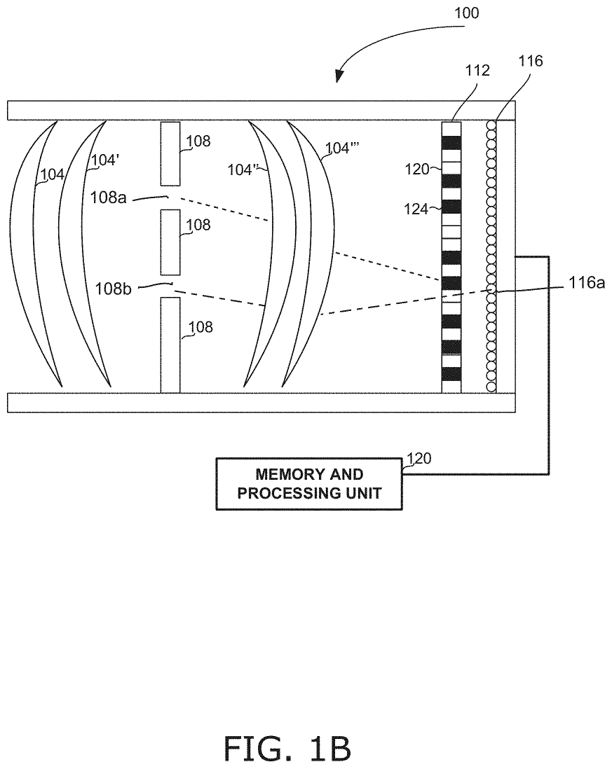

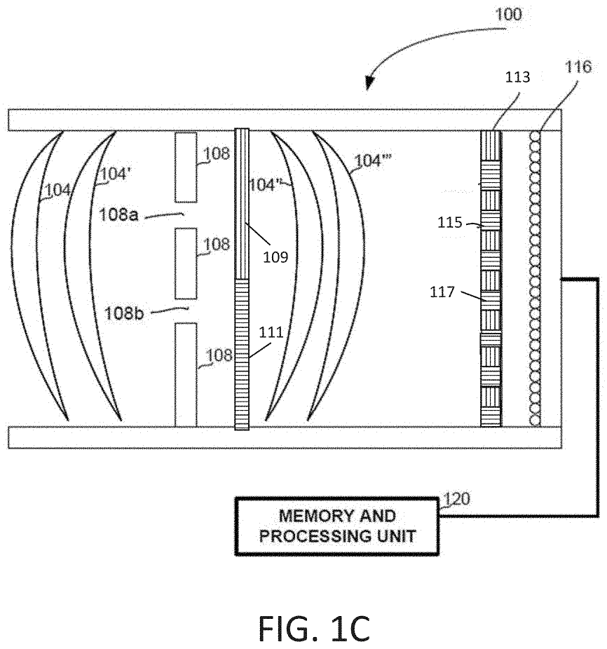

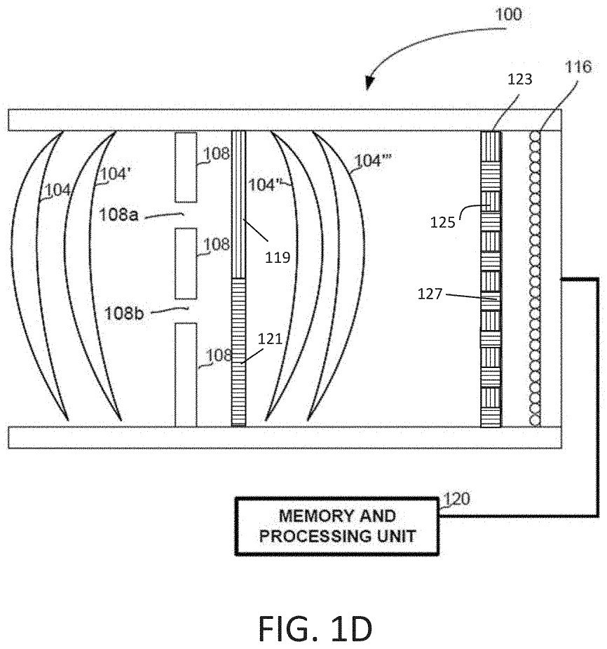

Referring now to FIG. 1A, a schematic illustration of a vertical cut through of a capture device, in accordance with some exemplary embodiments of the disclosed subject matter, is depicted. As used in the present disclosure, the term “capture device” refers to an imaging array including light sensors. The capture device, generally referenced 100, comprises one or more lenses such 104, 104′, 104″ or 104′. The lenses may be arranged in a lens housing (not shown). The lenses may be arranged as in any other device, such as authentication devices used in admission control systems, smartphones, or the like. Within the lens housing, or otherwise among or external to the lenses, device 100 may comprise an aperture structure 108, comprising two or more apertures 108a and 108b. The apertures 108a, 108b may be arranged along the same horizontal line, vertical line, or the like. Each aperture 108 may be round, square, rectangular or of any other shape. The apertures 108 may be aligned horizontally, vertically, or both horizontally and vertically. Each aperture 108a, 108b may have a dimension, such as a radius for a round aperture or an edge of a square aperture of between about 5% and about 50%, for example about 40% of the total length of aperture structure 108. The specific dimensions of the apertures may be determined based on considerations such as the amount of light available in an environment of the imaging array, or the overall size of the imaging array. The aperture structure may be made of a metal plate with openings on the aperture plane, a plastic plate with openings on the aperture plane, or the like. If made of an appropriate material, such as plastic, the aperture structure can be made a part of a camera module. Optionally, the aperture array 108 may be printed on one of the lenses 104. The lens array may be comprised of a lens stack structure which projects all the viewpoints onto one sensor, a multiple lens stack that uses prisms in order to project all the viewpoints onto one sensor, or the like.

Device 100 may further comprise sensor 116 comprising a multiplicity of pixels. The pixels of sensor 116 may also be referred to herein as “sensor pixels.” In some embodiments, sensor 116 may be a monochrome sensor, and in other embodiments it may be an RGB sensor. An advantage of using a monochrome sensor is that capturing color information requires adding a Bayer filter or coding the colors in a coding mask, which complicates the implementation and increases manufacturing cost. Moreover, capturing color information sacrifices resolution and light efficiency. As will be discussed further below, a grayscale image is sufficient for both anti-spoofing and facial verification.

Device 100 may further comprise binary coding mask 112. Binary coding mask 112 comprises transparent areas such as area 120 through which light can pass to sensor 116, and blocked areas 124 which stops light from getting to sensor 116. Binary coding mask 112 may be made of glass, fused silica, polymer or the like, having a pattern of pixels made of fused silica, metal coating, dark polymer, polarized glass, or bandpass filter (color) polymer, and may be priced similarly to a Bayer filter. A substrate for the pattern can be made from this glass, fused silica or a thin layer of a transparent polymer. It will be appreciated that binary coding mask 112 may be arranged such that each of its areas 120 or 124 corresponds to one pixel of sensor 116, and may thus be referred to as “pixel” as well. However, mask 112 may also be constructed from continuous blocked and non-blocked areas—i.e., areas larger than the dimensions of each sensor pixel. Either way, each location of mask 112 may be referred to as a pixel affecting the pixel from sensor 116 adjacent to it.

FIG. 1B illustrates the effect of the coding mask 112 on the absorption of light by pixels in the sensor 116. Pixel 116a, in the absence of the coding mask, would receive light both from aperture 108a (shown as a dashed line, and refracted by lenses 104″ and 104′) and from aperture 108b (shown as a long-dash-short-dash line, and refracted by lenses 104″ and 104′). However, blocked area 124 prevents the light ray from aperture 108a from reaching pixel 116a. By contrast, light from aperture 108b is able to pass through open area 120 and thereby reach pixel 116a.

As depicted in FIG. 1A, blocked areas 124 and open areas 120 may form a random pattern—i.e., they need not alternate in a repeated pattern. In some embodiments, blocked areas 124 block light from each respective aperture from reaching at least 25% and at most 75% of the plurality of pixels in pixel array 116. In some such embodiments, the blocked areas 124 block light from each respective aperture from reaching at least 40% and at most 60% of the plurality of pixels.

In another embodiment illustrated in FIG. 1C, aperture structure 108 may comprise two apertures 108a, 108b, each comprising, having therein, or covered by a polarized filter, such that the light coming through the aperture is affected by the filter. The polarized filter includes filter 109 associated with aperture 108a and filter 111 associated with aperture 108b. The filters 109, 111 of the two apertures 108a, 108b may be at a phase difference of about 90° to each other. A polarized filter array 113 is configured adjacent to the sensor 116. Every pixel on sensor 116 may comprise or be adjacent to a polarized filter 115 or 117 adjusted to one of the polarized filters. In the illustrated embodiment, filters 115 have the same polarization as filter 109, and filters 117 have the same polarization as filter 111. In the illustration of FIG. 1C, each filter section 115, 117 in the array 113 appears wider than the size of corresponding pixels in sensor 116. In alternative embodiments, as discussed above in connection with FIG. 1A, each filter 115, 117 may be approximately the same size as a pixel in sensor 116, so that there is a 1:1 correspondence between filters 115, 117 and corresponding pixels. Thus, each pixel may measure light received through exactly one aperture 108a or 108b. The phase each pixel is associated with may be selected randomly, pseudo randomly, or using any predetermined pattern.

In yet another embodiment illustrated in FIG. 1D, aperture structure 108 may comprise two or more apertures 108a, 108b, each comprising, having therein or covered by a bandpass wavelength filter, such that the light coming through the aperture is affected by the filter. The filters 119, 121 of any two apertures 108a, 108b may have no overlapping frequencies. A bandpass filter array 123 is configured adjacent to the sensor 116. Every pixel on sensor 116 may comprise or be adjacent to a bandpass wavelength filter 125 or 127 corresponding randomly to the wavelengths of one of the aperture filters 119, 121. In the illustrated embodiment, filters 125 permit the same frequencies as filter 119, and filters 127 permit the same frequencies as filter 121. As in FIG. 1C, each filter 125, 127 in the array 123 may be relatively wider than the size of pixels in sensor 116, or may be approximately the same size as a pixel in sensor 116, so that there is a 1:1 correspondence between filters 125, 127 and corresponding pixels. The wavelength each pixel is associated with may be selected randomly, pseudo randomly, or using any predetermined pattern. The wavelengths may be in the visual range (e.g., using RGB filters). In addition or alternatively, the wavelengths may be in the near-infrared range. The near-infrared range is useful for imaging in low-light situations, e.g. at night.

In each of the embodiments described above, the number of effective pixels for each viewpoint may be the resolution of sensor 116 divided by the number of apertures. For example, if there are two apertures 108, and sensor array 116 is 1024 pixels wide, the effective number of pixels viewing light from each aperture may be 512 pixels. Alternatively, it is possible that certain pixels may receive light from more than one aperture, so that the number of effective pixels for each viewpoint may be more than the ratio of pixels to apertures.

An image formed on sensor 116 may be transferred to memory and processing unit 120 for processing, including for example determining whether the depicted image is of a 3D surface of an object or an image thereof, and whether the depicted image is of the same surface of an object as an image stored in memory.

For simplicity, the discussion below is presented with reference to the embodiment of FIG. 1A, including coding mask 112. However, one of skill in the art may recognize that the equations and algorithms presented below apply equally well to the embodiments of FIGS. 1C and 1D, as well as to any other structure in which light from different apertures 108 may be allowed to reach only a portion of sensor pixels in a sensor array 116.

For simplicity, the aperture structure is assumed to have two apertures, arranged horizontally. Each such aperture creates a coded image on sensor 116, the coded image Cᵢ referred to as a view. Thus, two apertures create views C₀ and C₁. Each pixel at the spatial location (u,v) in the coded image, CI, can thus be modeled as:

CI(u,v)=Σᵢ viewᵢ(u,v)φᵢ(u,v) i=0,1 (1)

wherein viewᵢ (view₀ or view₁) is the coded image as seen from the corresponding aperture (wherein the image may comprise also pixels lighted by light received from the other aperture), and φᵢ(u,v) is the pattern of light received by the sensor when only the corresponding aperture is open. Each pixel in the coded image (also referred to herein as an “image pixel”) is thus the sum of the light shed on it through the apertures, provided that the respective pixel can be seen from the aperture and is not blocked.

As discussed above, the coding mask 112 may have a random distribution of blocked 120 and non-blocked areas 124, which is referred to in the equations below as Φ. This random distribution may lead to a random distribution of blocked and non-blocked pixels of the sensor 116, in association with any of the apertures 108. Thus, for each aperture, SMi may denote a “sparse mask” indicating the pixels in which light from only a particular viewᵢ is captured on the sensor:

SMi=II[φᵢ>0]⊕II[φ₁₋ᵢ=0] (2)

wherein II is the indicator function, being equal to 1 when the statement in brackets ([ ]) is correct and 0 otherwise, and ⊕ is element-wise OR operator. Therefore, view_{i,s} which is a “free” reconstructed sparse view, comprised of only the pixels accessible to light coming from the i-th aperture, may be obtained by:

view_{i,s}=CI⊕SMᵢ (3)

wherein CI is the function described above in equation (1), ⊕ is the element wise OR operator, and SMᵢ is the function described above in equation (2).

Once the two views are available, the blocked pixels in each sparse view may be calculated by interpolation, in one or two dimensions. The interpolation is performed according to any method known to those of skill in the art. Processing circuitry in the memory and processing unit 120 thus generates an interpolated image from each of the sparse views.

It is appreciated that the disparity map of a plane captured in a stereo setting, also referred to herein as a “planar disparity function,” is also a plane, defined in 3D space by the basic equation for a plane:

c=ax+by+z (4)

In a standard stereo setting, the transformation between Euclidean and image spaces is given by:

$$x = \frac{B}{d} ( u - {u}_{0} ) ; y = \frac{B}{d} ( v - {v}_{0} ) ; z = \frac{B}{d} {f}_{u} \qquad ( 5 )$$

wherein B is the baseline (i.e., the linear distance between the apertures), d is the disparity measured at the pixel (u, v), (u0, v0) is the principal point of the image, and fᵤ is the pixel focal length. Combining equations (4) and (5), provides:

$$d ( u , v ) = a \frac{B}{c} u + b \frac{B}{c} v + \frac{B}{c} ( {f}_{u} - {au}_{0} - {bv}_{0} ) \qquad ( 6 )$$

Thus, the disparity is affine with respect to the pixel locations, i.e. the disparity is also a plane. It will be appreciated that the coefficients

$$a \frac{B}{c} , b \frac{B}{c} and \frac{B}{c} ( {f}_{u} - {au}_{0} - {bv}_{0} )$$

can be computed from the disparity at three different points without calculating a, b, c, B, fᵤ, u₀ and v₀. Since the disparity map in the case of a 2D image is a plane, the disparity may be obtained for a few points, for example three points, optionally plus a few points for covering up for noise. An affine disparity plane, Dₚₗₐₙₑ, corresponding to the three calculated disparity values may then be calculated.

Three or more points in one of the views, for example in view₀, may then be projected to the other view view₁, to yield a projected view view′_{1,s} using the corresponding disparity Dₚₗₐₙₑ for each point as follows:

view_{1,s}′(u,v)=view_{0,s}(u+Dₚₗₐₙₑ(u,v),v) (7)

A similarity measure can then be applied between the points in the projected first view, being view_{1,s}′(u,v) and the corresponding interpolated captured sparse view, being view₁. The corresponding interpolated captured sparse view is also referred to herein as the “other” interpolated image, i.e., the interpolated image that is not transformed into a projected image. This similarity is expected to be lower for captured images of 3D surfaces, which have non-planar disparity maps. Because a disparity map for a three-dimensional object is not planar, the three-dimensional object is expected to deviate from the planar disparity function. This similarity measure is accordingly used to determine conformance of the planar disparity function with the interpolated images of the surface of the object.

In some embodiments, comparing average l1 (L1) distance between cubic interpolated sparse images may provide indicative results, as will be described below in connection with experimental data. Other metrics may also be used.

If the distance is high, for example exceeds a predetermined threshold, the image may be assumed to be an image of a 3D surface and not a spoofing attempt. Use of a predetermined threshold permits a tolerance for minor deviation from the planar disparity function for two-dimensional objects, or spoofing objects that have a small amount of depth (for example, a picture which is not aimed at the imaging array in a perfectly planar fashion). The device thus provides a low-computation and low-cost solution for distinguishing between 2D and 3D objects.

Optionally, the comparison of the projected view and the other interpolated view may be performed on a pixel-by-pixel basis. For example, the processing circuitry may be configured to check a conformance at a third pixel only if the first two checked pixels indicate that the object is two-dimensional. Advantageously, it is thereby possible to further streamline the process of comparing the projected image with the other interpolated image.

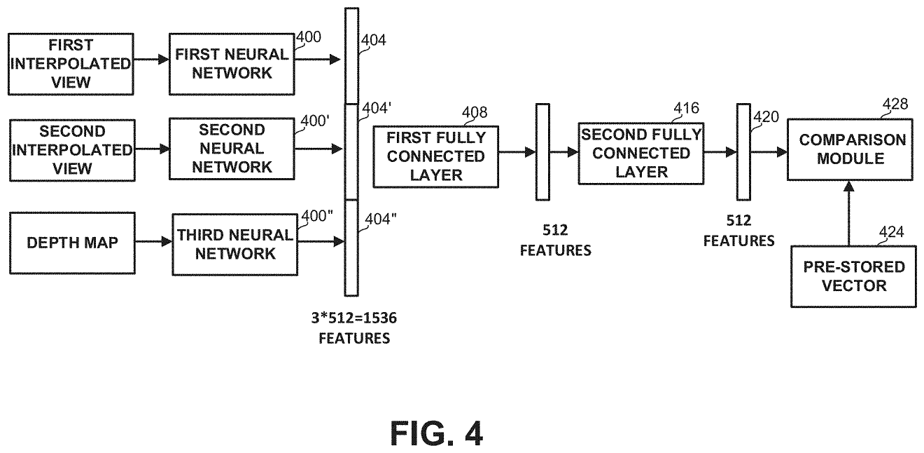

Face verification may then be subsequently performed in order to authenticate the user, as will be described below in connection with FIG. 4.

In some exemplary embodiments, binary coding mask 112 may have 50% light efficiency, i.e., 50% clear pixels in. This provides for about a quarter of the pixels in each view to be affected by the light coming through exactly one of the apertures, and thus trivially reconstructed. Assuming a 1.3 mega pixel sensor, of 1080*1400 resolution, the reconstructed views yield 540*700 pixels, which are randomly spaced in the original resolution. Current RGB face recognition networks can operate with faces depicted in resolutions of 25-250 pixels. Thus, the interpolated reconstructions may be sufficient for the task of authentication, as also shown in experiments.

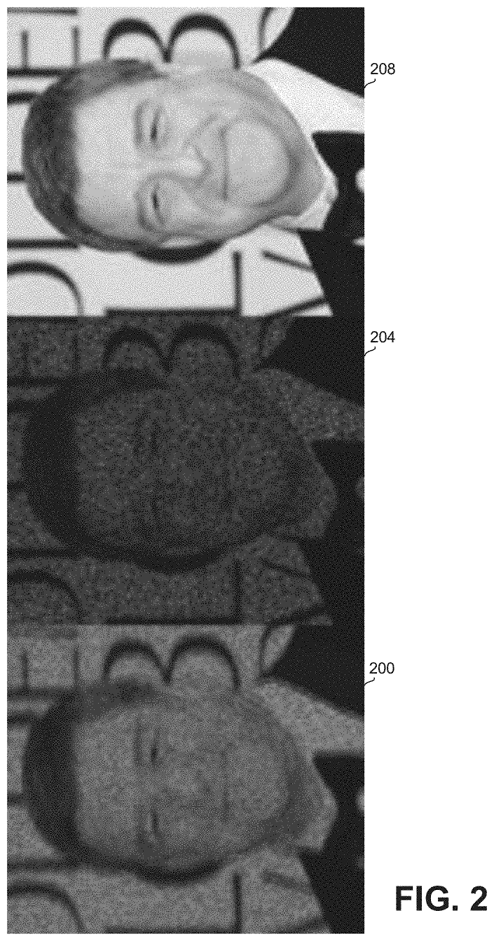

FIG. 2 depicts coded, sparse, and interpolated images. Image 200 shows the coded image as received by a monochrome sensor, i.e., the image in full resolution, as would be seen by a conventional image sensor. Image 204 shows the sparse view based on the sensor pixels receiving light from only the left aperture, and image 208 shows the interpolated view of the same image. Although the reconstruction is based on only about a quarter of the sensor pixels, the final interpolated reconstruction is clear and provides good results in face authentication. Moreover, downscaling to the identification network input resolution, the information loss is even less significant.

After having verified anti-spoofing, in order to authenticate the image, a full disparity map may be obtained from the two views, which provides depth information of the captured image. Obtaining the full disparity map requires applying the planar disparity function described above in connection with equations (5) and (6) to each of the image pixels, rather than only three to eight image pixels as required for the anti-spoofing detection. Thus, the mathematical calculations required are significantly more robust. One advantage of embodiments of the present disclosure is that the device need not engage in these more robust mathematical calculations until first verifying that the imaged surface is three-dimensional.

The complete disparity map may be easily transformed into a depth map, because the disparity between an interpolated view and a projected view, at every point, is a function of the depth of the 3D image at that point. Accordingly, in the description of the facial authentication procedure below, the terms “disparity map” or “complete disparity map” and “depth map” are used interchangeably.

The two views and the depth map may be fed into a network in order to authenticate it, i.e., determine whether the imaged object, e.g. the face, is the same as a pre-stored image of an object. The face authentication is further detailed in association with FIG. 4 below.

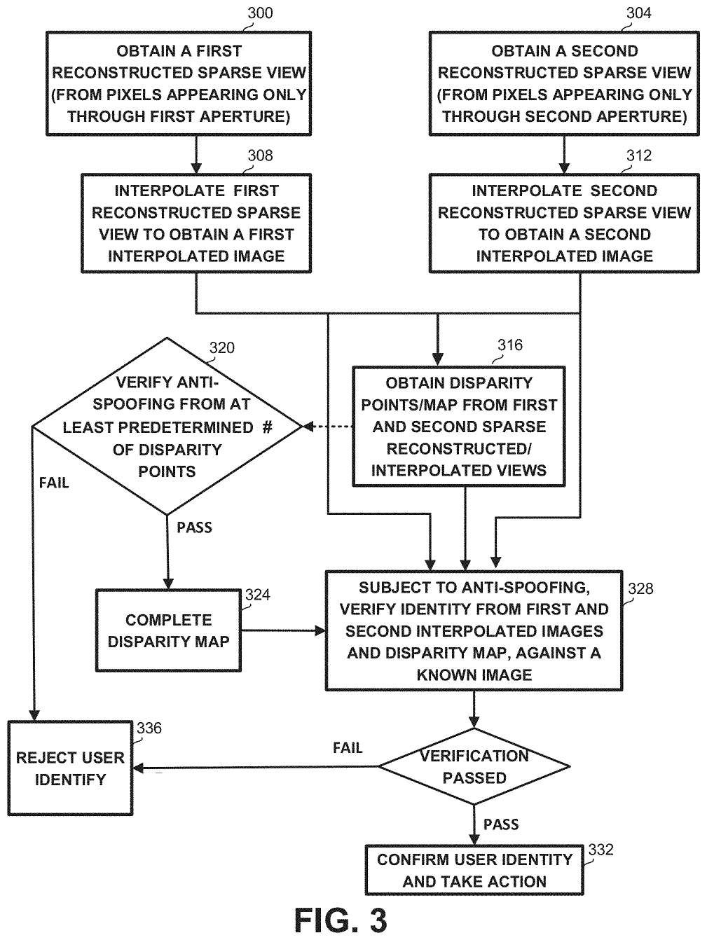

Referring now to FIG. 3, a flowchart of the method for spoofing-resilient authentication is shown, in accordance with some exemplary embodiments of the disclosed subject matter.

At steps 300 and 304, first and second reconstructed sparse views may be received from pixels lit only by the first and second apertures, respectively. The views may be obtained using equation (3) above, once the sparse masks are obtained in accordance with equation (2).

At steps 308 and 312, the other pixels in the first and second sparse views, respectively, may be interpolated, according to the values of the available pixels.

At step 316, at least a predetermined number of disparity points may be obtained. For example, as discussed above, three disparity points may be determined, which are the minimal number to determine the coefficients of the planar disparity function, plus an additional one to five in order to rule out noise and ensure reliability of the calculations. Depending on the application, the full disparity map may be obtained and a predetermined number of points may be selected. A disparity plane may be determined based on the points.

On step 320, based on the disparity plane and the two interpolated views, anti-spoofing may be determined, for example in accordance with equation (7) above. Thus, it may be determined whether the two views are of a 3D surface of an object, or a 2D image of an object.

If anti-spoofing verification has passed, the views may be assumed to be of a 3D object, then if a disparity map has not been calculated before, it may be completed at step 324.

Then at step 328, subject to the anti-spoofing passed, a claimed identity may be verified upon the two sparse interpolated images and the disparity map. The verification determines whether the captured object is the same as an object whose image or characteristics thereof is pre-stored. The verification is further detailed in association with FIG. 4 below.

Subject to successful verification, the identity may be confirmed on step 332, and a corresponding action may be taken, such as opening a door, enabling access to a device, or the like.

If the anti-spoofing or the identity verification failed, then at step 336 the user identity may be rejected. Optionally, an action may be taken, such as locking the device, setting off an alarm, or the like.

Referring now to FIG. 4, a schematic illustration of an exemplary computational setting for training a neural network and authenticating an object is shown. In an exemplary embodiment, a multi-view convolutional neural network may be employed, in which different convolutional neural networks learn from 2D projections of a 3D object. Shared weights are assigned for processing various projections of the 3D object, followed by a view pooling, i.e., max pooling of the feature vectors at the output of each branch. The combined, pooled feature vector is fed to a second convolutional neural network that outputs the final embedding.

Accordingly, the first monochrome interpolated view, the second monochrome interpolated view and the depth map may be fed, respectively, into a first neural network 400, a second neural network 400′ and a third neural network 400″. Each network may be, for example, a residual network which extracts features from the respective image, for example a first feature vector 404 of 512 entries from the first monochrome interpolated view, a second feature vector 404′ of 512 entries from the second monochrome interpolated view, and a third feature vector 404″ of 512 entries from the depth map.

The three vectors may be concatenated into a 1536 entry vector, and fed into a neural network of one or more layers, such as first and second fully connected layers 408 and 416, respectively, to obtain a unified 512 entry vector 420 representing the imaged object. The 512 features of vector 420 are then embedded in the final embedding. A triplet loss technique may be used on the final features of vector 420 to learn the embedding. It will be appreciated that the neural network can contain any number of internal layers, depending on the application, the available resources, or the like.

Vector 420, together with a pre-stored vector 424, for example a vector that has been extracted when the user first configured the device, when a person was enrolled with a system protecting a secured location, or the like, are fed into a comparison module 428. The pre-stored vector may be extracted from images captured during enrollment (e.g., during formation of a database of registered users of a system) similarly to the process described above for the images captured for verification. Comparison module 428 may compare the two vectors using any metrics, such as square sum. If the vectors are close enough, e.g. the distance is below a predetermined threshold, it may be assumed that the captured object is the same object as captured during enrollment, and access may be allowed, or any other relevant action may be taken. If the vectors are distant, for example the distance exceeds the predetermined threshold, access may be denied.

The convolutional neural network may be trained using a triplet loss technique and an ADAGRAD optimizer. Triplet loss is a loss function for machine learning algorithms whereby an initial, anchor input is compared to a positive (truthy) input and a negative (falsy) input. The distance from the baseline (anchor) input to the positive (truthy) input is minimized, and the distance from the baseline (anchor) input to the negative (falsy) input is maximized.

Thus, in one exemplary technique, each neural network 400, 400′, 400″ may be fine-tuned separately using both the triplet loss technique and the ADAGRAD optimizer, for 500 epochs of 1000 batches and 30 (person) identities per batch, with a learning rate of 0.01. These neural networks 400, 400′, 400″ may then be loaded to the integrated portions of the network and held constant, while the two fully connected layers 408, 416 are trained from scratch. The two fully connected layers 408, 416 may be trained in a similar fashion, but only sampling 15 identities per batch and with a higher learning rate of 0.1. The entire network may then be trained end-to-end, with a learning rate of 0.01 for five hundred more epochs, in a similar way to the training of layers 408, 416.

Due to the relative rarity of facial recognition datasets employing monochromatic images, it is advantageous, in some embodiments, to develop a dataset for training the neural networks. This is particularly advantageous because the anti-spoofing technique may be performed with a monochromatic sensor, and avoiding the use of RGB sensors greatly reduces the price and simplifies the computational power required for the verification process.

One approach involves creating 3D face models from RGB images of existing faces in training databases. The 3D model of each face may include a point cloud, a triangulated mesh, and a detailed texture. Using the relationship between depth and disparity, it is possible to convert the point cloud to a disparity map and use it to project the model into multiple views. The projected views correspond to the views that are generated by the imaging array of FIGS. 1A-1D. This process gives better disparity maps compared to those calculated from direct point cloud projections. Optionally, it is possible to set the disparity parameters of the different views obtained from the model based on properties of the imaging array that will be used for image verification. This allows transferring networks trained on the existing faces in the training databases to the data generated by the imaging array.

In addition to using images of existing faces in training databases, it is also possible to use the imaging array itself to capture a large number of actual faces, for example around 100 faces, as part of the training process. These faces may be used to test the anti-spoofing mechanism and to assess the ability of the identity verification network to generalize to real data vs. simulated light field views. In certain embodiments, it is possible to record views of the actual faces without a coding mask, and to simulate the effect of the coding mask.

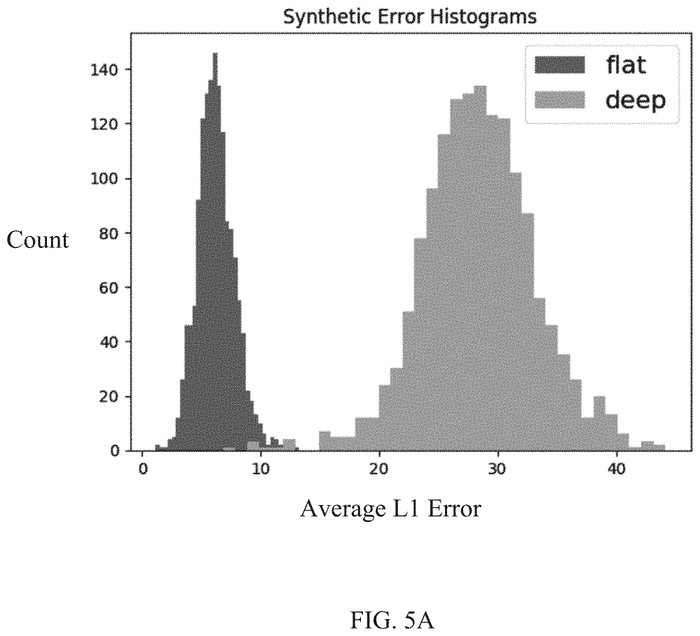

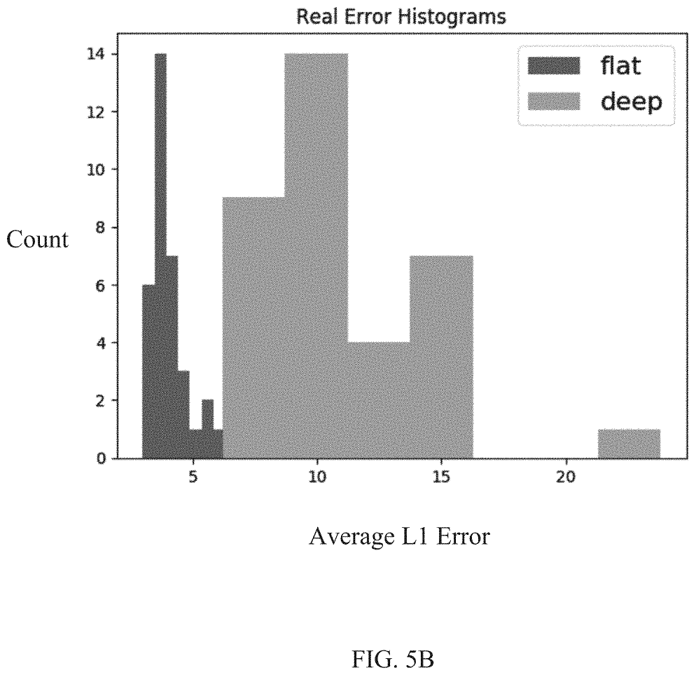

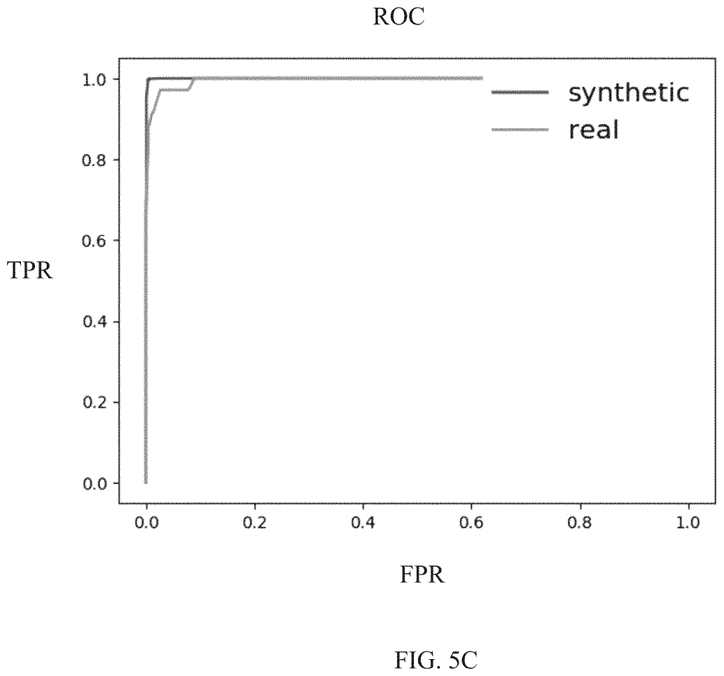

Referring now to FIGS. 5A-5C, the anti-spoofing functionality was experimentally tested on both the data sets generated from synthetic faces and on the data sets from actual faces. Referring first to FIG. 5A, a grayscale first view was projected to a “flat” second view, by randomized disparity plane parameters. Then, the acquisition process was simulated, resulting in sparse views of both the real and “flat” projections. Given a sparse first view and a sampled disparity, the projected sparse second view was created. The similarity between the captured (simulated) and projected sparse second views, based on the l1 loss on their bicubic interpolations. As shown in FIG. 5A, the error in the flat case (left histogram) is generally smaller than that of the 3D faces (right histogram), indicating that the views are of a printed image of a face. In FIG. 5B, the same experiment was performed on the data sets from the actual faces. Again, a separation was seen between the flat views (left histogram) and 3D views (right histogram). The ROC (receiver operating characteristic) curves of the anti-spoofing el-error based classifier are shown in FIG. 5C, with the left curve measuring the experiments with the synthetic faces, and the right curve measuring the experiments with the real faces.

Experimental results also demonstrated that the system distinguished properly between curved 2D images and actual faces. For example, a 2D image in a spoofing attack was alternatively presented in a printed image, on a smartphone, or on a curved surface. In each case, the l1 loss for the 2D images was lower than that of the faces.

Optionally, for l1 loss values that are close to the experimental threshold between 2D and 3D images, a subsequent verification may be performed on depth images. Having the verification done also on depth images afterwards prevents more complicated spoofing scenarios. Given the success of the anti-spoofing test in typical cases, this will be advantageous only in a small fraction of cases of 2D scans, which were not affirmatively identified with the first anti-spoofing test.

To test the capability of the system for facial identification, a 10-fold cross-validation experiment was performed, in which nine of the ten folds were used in the three-step training procedure described in relation with FIG. 4, and the performance is evaluated on the 10^{th} fold. In this case, none of the test identities were present during training. A 99.5% average accuracy was generated for identifying grayscale images of the synthetic faces following training, compared to 81.1% accuracy for grayscale images before training. Fine-tuning the pre-trained model (i.e., on a single “branch” of a neural network 404, 404′, or 404″) on a three channel image containing two grayscale views and a depth channel increased the accuracy to 90%. The smart addition of depth information increased the accuracy of the results by an additional 9.5%. Prior experiments on the RGB versions of the synthetic images were able to obtain an accuracy of 99.6%; thus, the trained neural networks were able to achieve results virtually identical to the prior results, but on grayscale images.

Similarly, on the data set obtained from actual faces, the network trained on synthetic faces was able to achieve 91.2% accuracy on randomly sampled pairs of matching and mismatching identities. End-to-end fine tuning on the system data enabled an increase in accuracy up to 98.75%. As with the synthetic face data, the test was done in an open set manner, with the people in the test set not being part of the group on the training set.

Optionally, it may be possible to improve the training of datasets based on actual faces, which may be smaller datasets than datasets of synthetic faces, by using generative tools such as SimGAN. (semantic image manipulation using generative adversarial networks). In addition or alternatively, a more sophisticated augmentation technique may be used during training.

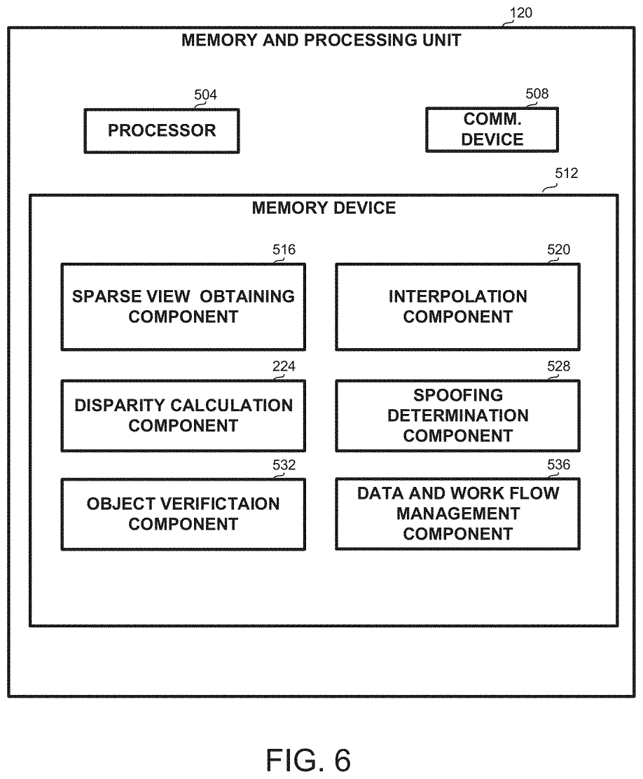

Referring now to FIG. 6, a block diagram of a memory and processing unit 120, configured for example for object verification and anti-spoofing, is disclosed, in accordance with some exemplary embodiments of the disclosed subject matter.

Memory and processing unit 120 may be embedded within one or more computing platforms, which may be in communication with one another.

Memory and processing unit 120 may comprise a processor 504 which may be one or more Central Processing Unit (CPU), a microprocessor, an electronic circuit, an Integrated Circuit (IC) or the like. Processor 504 may be configured to provide the required functionality, for example by loading to memory and activating the modules stored on storage device 512 detailed below. It will also be appreciated that Processor 504 may be implemented as one or more processors, whether located on the same platform or not.

Memory and processing unit 120 may communicate via communication device 508 with other components or computing platforms, for example for receiving images and providing object verification and anti-spoofing results.

Memory and processing unit 120 may comprise a storage device 512, or computer readable storage medium. In some exemplary embodiments, storage device 512 may retain program code operative to cause processor 504 to perform acts associated with any of the modules listed below or steps of the method of FIG. 3 above. The program code may comprise one or more executable units, such as functions, libraries, standalone programs, executable components implementing neural networks, or the like, adapted to execute instructions as detailed below.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory chip, a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Storage device 512 may comprise sparse view obtaining component 516, for receiving or determining views comprise of pixels whose values are influenced by the light coming from one aperture only, as detailed on step 300 and 304 above.

Storage device 512 may comprise interpolation component 520 for interpolating the sparse views determined by sparse view obtaining component 516, as detailed in accordance with steps 308 and 312 above. Interpolation may be one dimensional, two dimensional, or performed by any other method.

Storage device 512 may comprise disparity calculation component 524, for calculating the disparity between two views using the planar disparity function, as detailed in accordance with steps 308 and 320 above. Disparity may be calculated for the full views or for a predetermined number of points within the images, for example three points and additional few, for example additional 1-5 points for overcoming noise and ensuring stability.

Storage device 512 may comprise spoofing determination component 528, for determining based on the interpolated views and the disparity calculated by disparity calculation component 524 whether the two views capture a 3D object, or a 2D image of an object, as detailed in accordance with step 316 above. As discussed above, a disparity may be calculated upon the three points using the planar disparity function, and if at least two points indicate that the object is 2D, additional points may be tested, and if at least one of them also indicates a 2D object, the result of the anti-spoofing test is a fail.

Storage device 512 may comprise object verification component 532, for verifying using the two interpolated images and the depth map, whether the images depict a known object, such as a face whose image is pre-stored or otherwise available to storage device 512, as detailed in association with FIG. 4 above.

Storage device 512 may comprise data and workflow management component 536 for activating the components, and providing each component with the required data. For example, data and workflow management component 536 may be configured to obtain the images, invoke sparse view obtaining component 516 to create the sparse views, invoke interpolation component 520 with the sparse views for interpolating the sparse views, invoke disparity calculation component 524 for calculating the disparity based on the interpolated views, invoke anti-spoofing component 528 with the interpolated views and disparity map, and invoke object verification component 532 subject to successful anti-spoofing determination.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, any priority document(s) of this application is/are hereby incorporated herein by reference in its/their entirety.

1. A device for authentication of a three-dimensional object, comprising:
an imaging array having a sensor configured to generate first and second sparse views of a surface of the three-dimensional object that faces the imaging array; and
a processing circuitry configured to:
interpolate the first and second sparse views to obtain first and second interpolated images;
calculate a planar disparity function for a plurality of image pixels of one of the first or second interpolated images;
generate a projected image by displacing the plurality of image pixels of one of the first or the second interpolated images using the planar disparity function; and
compare the projected image with the other of the first or second interpolated images to determine conformance of the planar disparity function with the interpolated images of the surface of the object.

2. The device of claim 1, wherein the processing circuitry is configured to determine that the surface is three-dimensional when a deviation of the projected image and the other interpolated image from the planar disparity function is above a predetermined threshold.

3. The device of claim 2, wherein the processing circuitry is configured to calculate the deviation based on a calculation of an l1 loss between the projected image and the other interpolated image.

4. The device of claim 1, wherein the processing circuitry is configured to generate the projected image with between three and eight image pixels.

5. The device of claim 1, wherein the processing circuitry is configured to compare the projected image with the other interpolated image on a pixel-by-pixel basis.

6. The device of claim 1, further comprising a memory for storing images of surfaces of three-dimensional objects, and wherein the processing circuitry is configured to generate a depth map based on the first and second interpolated images, to extract features from the first and second interpolated images and the depth map into at least one network, and to compare the extracted features with features extracted from a corresponding image from a set of stored images, and to thereby determine whether the object is identical to an object imaged in the corresponding image.

7. The device of claim 6, wherein the at least one network comprises a multi-view convolutional neural network including a first convolutional neural network for processing features of the first interpolated image and generating a first feature vector, a second convolutional neural network for processing features of the second interpolated image and generating a second feature vector, a third convolutional neural network for processing features of the depth map and generating a third feature vector, and at least one combined convolutional neural network for combining the three feature vectors into a unified feature vector for comparison with a corresponding unified feature vector of the corresponding image.

8. The device of claim 6, wherein the stored images are images of faces.

9. A device for authentication of a three-dimensional object, comprising:
an image sensor comprising a plurality of sensor pixels configured to image a surface of the object facing the image sensor;
a lens array comprising at least first and second apertures,
at least one filter array configured to allow light received through the first aperture only to a set of first sensor pixels from the plurality of sensor pixels and light received through the second aperture only to a set of second sensor pixels from the plurality of sensor pixels; and
a processing circuitry configured to:
generate a first sparse view of the surface of the object from light measurement of the set of first sensor pixels and a second sparse view from light measurement of the set of second sensor pixels, and
to determine conformance of image pixels from the first and second sparse views with a planar disparity function calculated based on a baseline of the first and second apertures and a pixel focal length of the lens array.

10. The device of claim 9, wherein the processing circuitry is further configured to determine the conformance of the image pixels from the first and second sparse views with the planar disparity function by:
interpolating the first and second sparse views to obtain first and second interpolated images;
generating a projected image by displacing a plurality of image pixels of one of the first or the second interpolated images using the planar disparity function; and
comparing the projected image with the other of the first or second interpolated images.

11. The device of claim 10, wherein the processing circuitry is configured to determine that the surface is three-dimensional when a deviation of the projected image and the other interpolated image from the planar disparity function is above a predetermined threshold.

12. The device of claim 9, wherein the at least one filter array comprises a coding mask comprising at least one blocked area configured to block light from reaching one or more of the plurality of the sensor pixels.

13. The device of claim 12, wherein the at least one blocked area blocks light from reaching at least 25% and at most 75% of the plurality of sensor pixels.

14. The device of claim 9, wherein the at least one filter array comprises a filter associated with each aperture from the plurality of apertures, whereby each filter passes one or more wavelengths from a plurality of wavelengths, wherein no wavelengths passed by respective filters overlap, and wherein each sensor pixel from the plurality of sensor pixels is adjacent to a pixel filter passing at least part of the wavelengths from the plurality of wavelengths, whereby each sensor pixel measures light received through exactly one of the apertures.

15. The device of claim 9, wherein the aperture structure comprises a first aperture and a second aperture, wherein the at least one filter array comprises a first filter associated with the first aperture and a second filter associated with the second aperture, wherein the first filter and the second filter are at a phase difference of 90°, and wherein each sensor pixel from the plurality of sensor pixels is adjacent to a pixel filter having a phase corresponding to a phase of the first filter or the second filter, whereby each pixel measures light received through exactly one of the first aperture and the second aperture.

16. The device of claim 9, wherein the first aperture and the second aperture are arranged horizontally.

17. The device of claim 9, wherein the first aperture and the second aperture are arranged vertically.

18. The device of claim 9, wherein the plurality of apertures comprises at least two apertures arranged horizontally and at least two apertures arranged vertically.

19. A method for authentication of a three-dimensional object, comprising:
generating first and second sparse views of a surface of the three-dimensional object;
interpolating the first and second sparse views of the object to obtain first and second interpolated images;
generating a projected image by displacing a plurality of image pixels of one of the first or the second interpolated images using a planar disparity function; and
comparing the projected image with the other of the first or second interpolated images to determine a conformance of the planar disparity function with the interpolated images of the object.

20. The method of claim 19, further comprising determining that the surface is three-dimensional when a deviation of the projected image and the other interpolated image from the planar disparity function is above a predetermined threshold.

21-27. (canceled)
